(19) United States
(12) Patent Application Publication
(10) Pub. No.: US 2019/0335483 A1
(43) Pub. Date: Oct. 31, 2019

(54) Millimeter Wave Wireless Broadband Connectivity

(71) Applicant: Tubis Technology Inc., Pasadena, CA (US)

(72) Inventor: James Wang, Pasadena, CA (US)

(21) Appl. No.: 16/395,602

(22) Filed: Apr. 26, 2019

Related U.S. Application Data
(60) Provisional application No. 62/663,440, filed on Apr. 27, 2018.

(51) Int. Cl. H04W 72/12

(52) U.S. Cl. CPC H04W 72/1215; H04W 84/12

(57) ABSTRACT

A method of utilizing low-cost narrow bandwidth WiFi system or other low-cost <6 GHz system to realize a multi-giga bps wireless local access (last mile) system is proposed. The desired goal is to achieve a multi-giga bps system. In one embodiment, a mmWave converter takes one spatial beam/antenna of the WiFi device and shift in frequency domain such that multiple spatial beams can be aggregated into a wide bandwidth mmWave signal, e.g., conversion from WiFi spatial domain to mmWave frequency domain. A single mmWave beam can be used to transmit such wide bandwidth signal. Furthermore, a method of beam training is proposed to decide the best possible transmit beam and receive beam by employing the WiFi channel sounding and feedback protocol.

### CROSS REFERENCE TO RELATED APPLICATIONS

This application claims priority under 35 U.S.C. § 119 from U.S. Provisional Application No. 62/663,440, entitled “mmWave Wireless Broadband Connectivity,” filed on Apr. 27, 2018, the subject matter of which is incorporated herein by reference.

### TECHNICAL FIELD

The disclosed embodiments relate generally to wireless network communications, and, more particularly, to local access (last mile) connectivity in Millimeter Wave wireless communications systems.

### BACKGROUND

The bandwidth shortage increasingly experienced by mobile carriers has motivated the exploration of the underutilized Millimeter Wave (mmWave) frequency spectrum around 30 G and 300 G Hz for the next generation 5G broadband cellular communication networks. The available spectrum of mmWave band is hundreds of times greater than the conventional cellular system. The mmWave wireless network uses directional communications with narrow beams and can support multi-gigabit data rate. The underutilized bandwidth of the mmWave spectrum has wavelengths ranging from 1 mm to 100 mm. The very small wavelengths of the mmWave spectrum enable large number of miniaturized antennas to be placed in a small area. Such miniaturized antenna system can produce high beamforming gains through electrically steerable arrays generating directional transmissions.

Local Access (last mile) is a phase widely used in the telecommunications, cable television, and internet industries to refer to the final leg of telecommunications networks that deliver telecommunication services to retail end-users (customers). Many options are available for the last mile connectivity, which includes 1) cable: high development cost; 2) DSL phone line: limited bandwidth, higher development cost; 3) Outdoor WiFi: higher interference, limited range; 4) Fixed wireless point-to-point system using Dish Antenna: difficult to install (high accuracy aiming required) high gain dish, wind can affect antenna aiming (strong fixture, non-flexible dish needed), high installation cost; 5) Existing mmWave Systems (60 GHz, E band system using phased-Array antenna): easier to deploy, automate antenna aiming, low cost, but proprietary baseband equipment is usually expensive.

In order to adopt the existing mmWave system for the last mile local access, it is desirable to use very low cost WiFi equipment as broadband and IF solutions before converting to mmWave signals. However, there still exist certain issues. First, low cost low frequency system uses limited bandwidth (e.g., 802,11ac and 802.11ax provides up to 160 Mhz BW). Second, for multiple spatial streams, it is difficult to realize in outdoor environment since spatial diversity is limited (LOS only 1). For eight spatial streams in 802.11ac, the data rate can achieve 6.24 Gbps at 256QAM or 4.68 Gbps at 64QAM if eight spatial streams and long GI and 160 MHz bandwidth are used.

It is the objective of the present invention to provide a solution for realization of wideband mmWave system and for performing beam training for mmWave phased array antenna.

### SUMMARY

A method of utilizing low-cost narrow bandwidth WiFi system or other low-cost <6 GHz system to realize a multi-giga bps wireless local access (last mile) system is proposed. The desired goal is to achieve a multi-giga bps system. In one embodiment, a mmWave converter takes one spatial beam/antenna of the WiFi device and shift in frequency domain such that multiple spatial beams can be aggregated into a wide bandwidth mmWave signal, e.g., conversion from WiFi spatial domain to mmWave frequency domain. A single mmWave beam can be used to transmit such wide bandwidth signal. Furthermore, a method of beam training is proposed to decide the best possible transmit beam and receive beam by employing the WiFi channel sounding and feedback protocol.

Other embodiments and advantages are described in the detailed description below. This summary does not purport to define the invention. The invention is defined by the claims.

### BRIEF DESCRIPTION OF THE DRAWINGS

FIG. 1 illustrates a wireless fiber to home system having a local access system (UE) at client side connecting to a local access system (BS) at network side for wideband millimeter-wave (mmWave) wireless access in accordance with a novel aspect.

FIG. 2 is a simplified block diagram of a local access system that carry out embodiments of the present invention.

FIG. 3 illustrates simplified block diagrams of a WiFi AP at network side and WiFi module at client side that carry out embodiments of the present invention.

FIG. 4 illustrates a more detailed block diagram of a WiFi AP.

FIG. 5 illustrates the realization of wideband mmWave System by aggregating different spatial streams into a wideband mmWave signal.

FIG. 6 illustrates a first embodiment of realizing of wideband mmWave system.

FIG. 7 illustrates a second embodiment of realizing of wideband mmWave system.

FIG. 8 illustrates embodiments of beam training for mmWave systems using off-the-shelf throughput testing software or WiFi API running on WiFi devices.

FIG. 9 illustrates a WiFi protocol for channel sounding and feedback applied for beam training in mmWave systems.

FIG. 10 illustrates one embodiment of implementing sounding and feedback applied for beam training in mmWave systems.

### DETAILED DESCRIPTION

Reference will now be made in detail to some embodiments of the invention, examples of which are illustrated in the accompanying drawings.

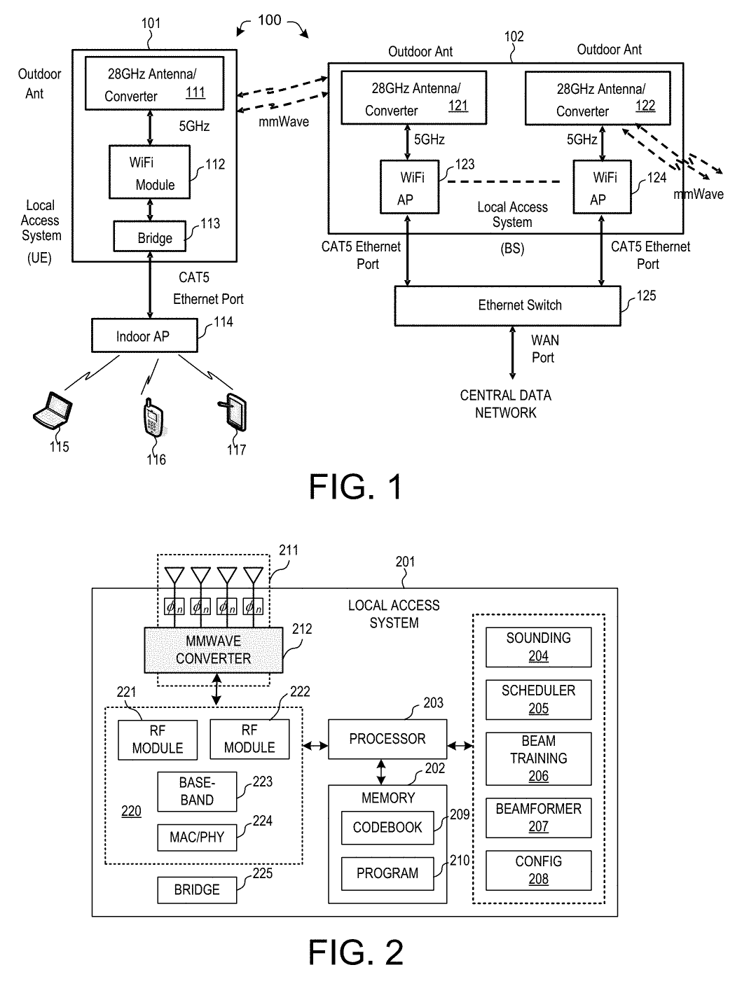

FIG. 1 illustrates a wireless fiber to home system 100 having a local access system (UE) at client side connecting to a local access system (BS) at network side for wideband millimeter-wave (mmWave) wireless access in accordance with a novel aspect. Wireless fiber to home system 100 comprises a client-side local access system 101 and a network-side local access system 102. The cellular network uses directional communications with narrow beams and can support multi-gigabit data rate. One example of such cellular network is a Millimeter Wave (mmWave) network utilizing the mmWave frequency spectrum. In such mmWave network, directional communications are achieved via beamforming, wherein a phased antenna array having multiple antenna elements are applied with multiple sets of beamforming weights (phase shift values) to form multiple beam patterns.

In antenna theory, a phased antenna array usually means an array of antennas that creates a beam of radio waves can be electronically steered to point in different directions, without moving the antennas. In the phased antenna array, the radio frequency current from the transmitter is fed to the individual antennas with the correct phase relationship so that the radio waves from the separate antennas add together to increase the radiation in a desired direction, while cancelling to suppress radiation in undesired directions. In the phased antenna array, the power from the transmitter is fed to the antennas through phase shifters, controlled by a processor, which can alter the phase electronically, thus steering the beam of radio waves to a different direction.

Local access system 101 comprises a 28 GHz outdoor antenna coupled to a mmWave converter 111, a WiFi module 112 coupled to the mmWave converter, and a bridge 113 coupled to the WiFi module and an indoor access point AP 114 via a CAT5 Ethernet port. The indoor AP 114 is connected to a plurality of client devices such as PC 115, cell phone 116, and handset 117. Local access system 102 comprises multiple 28 GHz outdoor antennas coupled to mmWave converters 121 and 122, multiple WiFi APs including WiFi AP 123 and 124 coupled to the mmWave converters. Each WiFi AP is connected to an Ethernet switch 125 via a CAT5 Ethernet port, and the Ethernet switch 125 is connected to a central data network for data access. Each WiFi module and WiFi AP operate in a regular WiFi basic service set (BSS), and the WiFi module at the client side is associated to one of the WiFi APs at the network side identified by a BSSID.

In order to adopt the existing mmWave system for the last mile local access, it is desirable to use very low cost WiFi equipment as broadband and IF solutions before converting to mmWave signals. However, the low cost and low frequency WiFi equipments use limited bandwidth (IEEE 802.11ac and IEE 802.11ax provide only up to 160 MHz bandwidth). It is also difficult to realize multiple WiFi spatial streams in outdoor environment since spatial diversity is limited (LOS only 1). On the other hand, the mmWave system has the advantage of high antenna gain and narrow beam, which provides long range, high degree of spatial reuse, flexible beam, and wider bandwidth allowing broadband transmission.

In accordance with one novel aspect, a method of utilizing low-cost narrow bandwidth WiFi system or other low-cost <6 GHz system to realize a multi-giga bps wireless local access (last mile) system is proposed. The desired goal is to achieve a multi-giga bps system. In one embodiment, take one spatial beam/antenna of the WiFi device and shift in frequency domain such that multiple spatial beams can be aggregated into a wide bandwidth mmWave signal, e.g., conversion from WiFi spatial domain to mmWave frequency domain. A single mmWave beam can be used to transmit such wide bandwidth signal. Furthermore, a method of beam training is proposed to decide the best possible transmit beam and receive beam by employing the WiFi channel sounding and feedback protocol.

In another advantageous aspect, since the mmWave signals have narrow directional beams, they allow multiple WiFi APs/BSSs to operate independently and simultaneously via spatially separated mmWave beams, and data traffic of the WiFi APs/BSSs can be aggregated via the Ethernet switch. This enables a Giga-bit network (one BSS) to become a 10 Giga-bit network (multiple BSSs connected with the Ethernet switch), which is normally very expensive. This type of architecture is done in Ethernet networks but not commonly done in traditional WiFi systems because lower frequency WiFi systems are broadcast with signals in omni-direction (there is no antenna beams). Therefore, this type of architecture can only be achieved in mmWave network with narrow and directional beams to allow multiple beams to operate simultaneously and independently.

FIG. 2 is a simplified block diagram of a wireless local access device 201 that carries out certain embodiments of the present invention. Device 201 has a mmWave phased-array antenna 211 and converter 212 having multiple antenna elements that transmits and receives radio signals, a WiFi module 220 comprising one or more RF transceiver modules 221 and 222, a baseband processing unit 223, and a MAC/PHY module 224, and optionally a bridge 225 if device 201 is a client-side device. The mmWave converter coupled with the phased-array antenna, receives mmWave signals from antenna 211, converts them to baseband signal via WiFi module, and sends them to processor 203. The mmWave converter also converts received baseband signals from processor 203 via WiFi module, converts them to mmWave signals, and sends out to antenna 211. Processor 203 processes the received baseband signals and invokes different functional modules and circuits to perform features in device 201. Memory 202 stores program instructions and data 210 and codebook 209 to control the operations of device 201. The program instructions and data 210, when executed by processor 203, enables device 201 to apply various beamforming weights to multiple antenna elements of antenna 211 and form various directional beams for communication.

Device 201 also includes multiple function modules and circuits that carry out different tasks in accordance with embodiments of the current invention. The functional modules and circuits can be implemented and configured by hardware, firmware, software, and any combination thereof. For example, device 201 comprises a sounding circuit (for UE) 204 for performing channel sounding and feedback, a scheduler (for BS) 205 for scheduling data traffic, a beam training circuit 206 for performing beam training via channel sounding and feedback, a beamformer 207 for applying different beamforming weights, and a configuration and control module 208 for providing and obtaining various control and config information to carry out embodiments of the present invention.

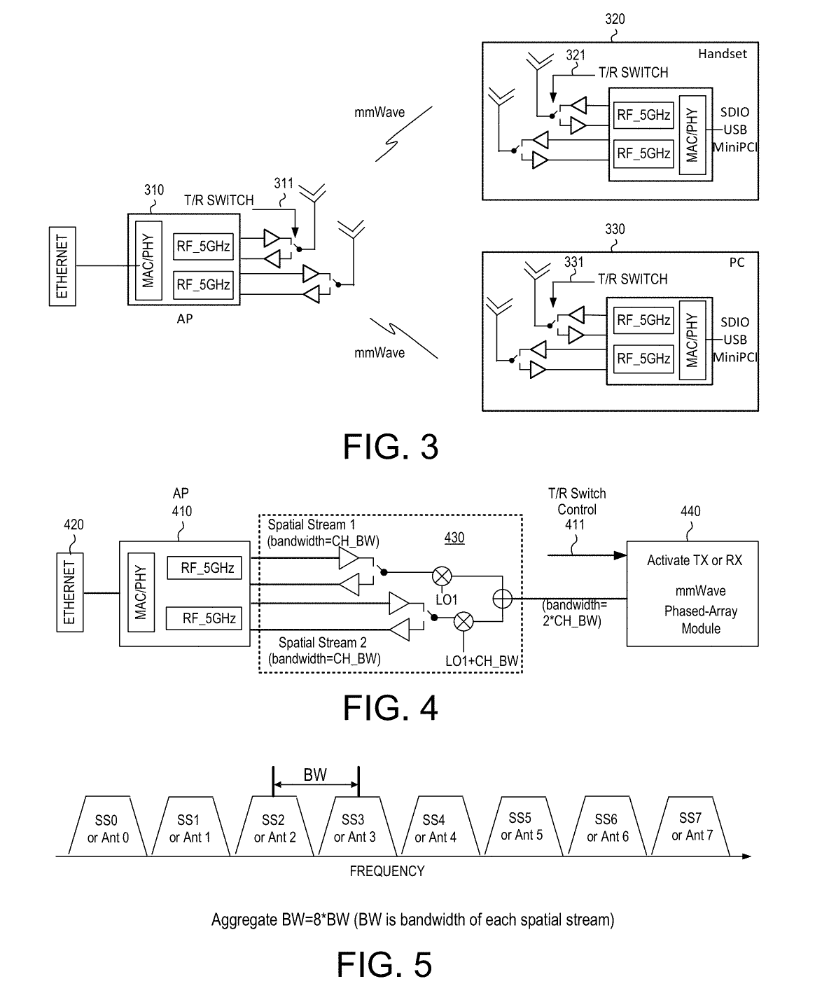

FIG. 3 illustrates simplified block diagrams of a WiFi AP 310 at network side and WiFi modules 320 and 330 at client side that carry out embodiments of the present invention. WiFi AP 310 is connected to an Ethernet switch and a 28 GHz antenna/converter controlled by a transmit or receive (T/R) switch 311. WiFi AP 310 comprises multiple RF_5 GHz modules and a MAC/PHY circuit handling MAC and PHY protocol layers. The TR switch 311 controls to activate either transmitting or receiving at the mmWave converter. Similarly, WiFi module 320 or 330 is connected to a bridge via SDIO or USB or Mini PCI interface and a 28 GHz antenna/converter controlled by a transmit or receive (T/R) switch 321 or 331. WiFi module 320 or 330 comprises multiple RF_5 GHz modules and a MAC/PHY circuit handling MAC and PHY layer protocol. The T/R switch 311 controls to activate either transmit or receive at the mmWave converter.

FIG. 4 illustrates a more detailed block diagram of a WiFi AP 410. WiFi AP 410 comprises multiple RF modules and a MAC/PHY layer handling entity. WiFi AP 410 is coupled to an Ethernet switch 420 at the network side for data traffic with a central data network. WiFi AP also connects to a mmWave converter 430, which is connected to a mmWave phased-array antenna module 440. In the transmit direction, the mmWave converter 430 receives WiFi signal from WiFi AP 410 and up-converts WiFi signal to mmWave signal, which is transmitted out via the mmWave phased-array antenna 440. In the receive direction, the mmWave converter 430 receives mmWave signal via the mmWave phased-array antenna 440 and down-converts to WiFi signal, which is processed by WiFi AP 410. The transmitting and receiving operations are controlled by a T/R switch 411 providing a switch control signal to activate TX or RX of the mmWave phased-array antenna module 440. Furthermore, the WiFi signal consists of multiple spatial streams correspond to each RF_5 GHz module having a narrow channel bandwidth, e.g., spatial stream 1 and spatial stream 2 having a bandwidth=CH_BW. The mmWave converter 430 up-converts the WiFi spatial streams into a wideband mmWave signal by aggregating the multiple WiFi spatial streams into a wideband mmWave signal, e.g., the mmWave signal having a bandwidth=2*CH_BW.

FIG. 5 illustrates the realization of wideband mmWave System by aggregating different spatial streams into a wideband mmWave signal. In order to adopt the existing mmWave system for the last mile local access, it is desirable to use very low cost WiFi equipment as broadband and IF solutions before converting to mmWave signals. However, the low cost and low frequency WiFi equipments use limited bandwidth (IEEE 802.11ac and IEE 802.11ax provide only up to 160 MHz bandwidth). It is also difficult to realize multiple WiFi spatial streams in outdoor environment since spatial diversity is limited (LOS only 1). On the other hand, the mmWave system has the advantage of high antenna gain and narrow beam, which provides long range, high degree of spatial reuse, flexible beam, and wider bandwidth allowing broadband transmission. The goal is to utilize low-cost narrow bandwidth WiFi system or other low-cost <6 GHz system to realize a multi-giga bps wireless local access (last mile) system.

In a preferred embodiment, in the transmit direction, take one spatial beam/antenna of the WiFi device and shift in frequency domain such that multiple spatial beams can be aggregated into a wide bandwidth mmWave signal, e.g., conversion from WiFi spatial domain to mmWave frequency domain. A single mmWave beam can be used to transmit such wide bandwidth signal. As illustrated in FIG. 5, a WiFi signal consists of eight spatial streams SS0 to SS7 (or Ant0 to Ant7), each having a narrow bandwidth of BW. After converting from WiFi spatial domain to mmWave frequency domain, the wideband mmWave signal has an aggregate wide bandwidth of 8*BW. In the receiving direction, the wideband mmWave signal can be converted to multiple narrowband WiFi spatial streams in spatial domain.

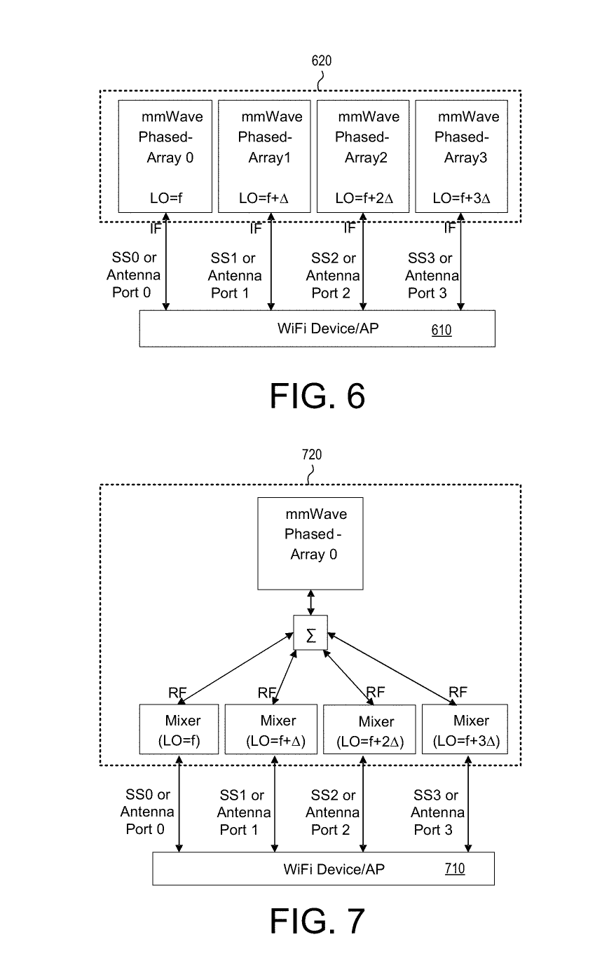

FIG. 6 illustrates a first embodiment of realizing of wideband mmWave system. In the embodiment of FIG. 6, the WiFi device, e.g., either at the client side WiFi module or at the network side WiFi AP 610 is connected to a mmWave converter and phased-array 620. The WiFi device comprises four RF modules, each RF module outputs a corresponding WiFi spatial stream SS0-SS3 (or Antenna Port0 to Antenna Port 3) having a narrow bandwidth of BW. The multiple WiFi spatial streams are up-converted to different mmWave phased-arrays by applying with a different frequency offset. For example, SS0 is mapped from spatial domain to frequency domain with LO=f by mmWave Phased-Array 0, SS1 is mapped from spatial domain to frequency domain with LO=f+Δ by mmWave Phased-Array 1, SS2 mapped from spatial domain to frequency domain with LO=f+2Δ by mmWave Phased-Array 2, and SS3 is mapped from spatial domain to frequency domain with LO=f+3Δ by mmWave Phased-Array 3. The mmWave converter and phased-array 620 then outputs an aggregated mmWave signal with an aggregated bandwidth of 4*BW.

FIG. 7 illustrates a second embodiment of realizing of wideband mmWave system. In the embodiment of FIG. 7, the WiFi device, e.g., either at the client side WiFi module or at the network side WiFi AP 710 is connected to a mmWave converter and phased-array 720. The WiFi device comprises four RF modules, each RF module outputs a corresponding WiFi spatial stream SS0-SS3 (or Antenna Port0 to Antenna Port 3) having a narrow bandwidth of BW. The multiple WiFi spatial streams are up-converted by applying with a different frequency offset and then aggregated to the same mmWave phased-array. For example, SS0 is mapped from spatial domain to frequency domain with LO=f by Mixer0, SS1 is mapped from spatial domain to frequency domain with LO=f+Δ by Mixer1, SS2 mapped from spatial domain to frequency domain with LO=f+2Δ by Mixer2, and SS3 is mapped from spatial domain to frequency domain with LO=f+3Δ by Mixer3. The mmWave phased-array 0 then aggregates the Mixer output and transmits an mmWave signal with an aggregated bandwidth of 4*BW.

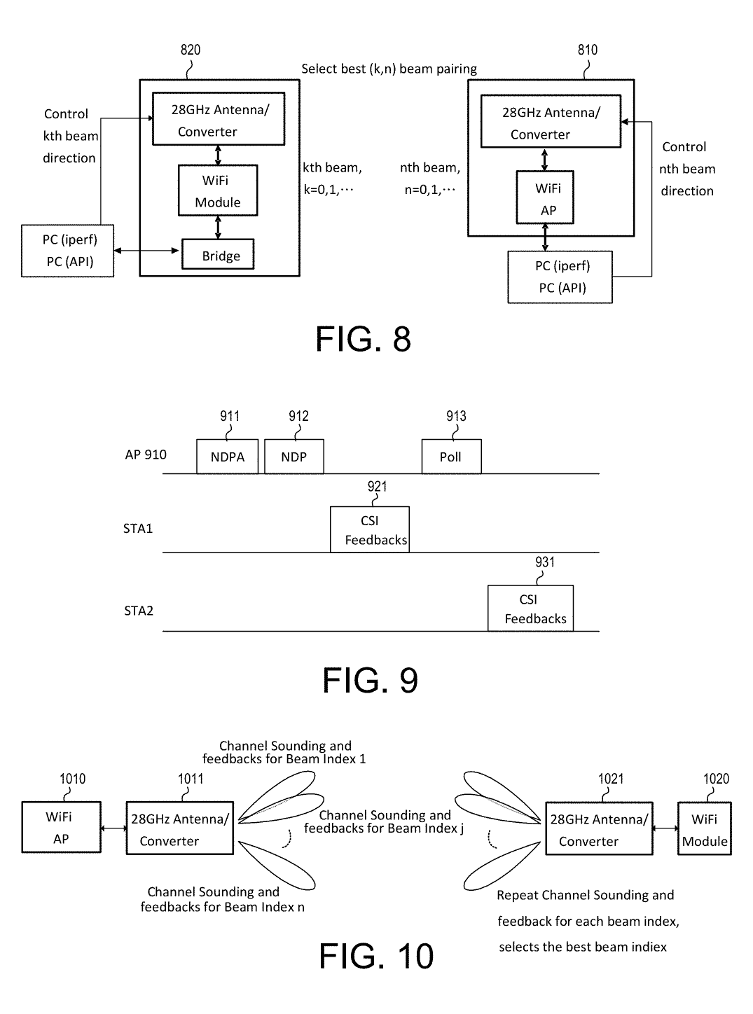

FIG. 8 illustrates embodiments of beam training for mmWave systems using off-the-shelf throughput testing software or WiFi API running on WiFi devices. For beam training, mmWave has a beam codebook consisting of a set of antenna beamforming weight vectors, each vector produces an antenna beam. The goal of beam training is to select a suitable beam among the beam codebook for each remote device. In a first method, the beam training can use off-the-shelf throughput testing software (such as iperf, which runs on WiFi devices). For WiFi AP 810, it sequentially sets the mmWave array to beam n (i.e., uses nth antenna weight vector) where n=0, 1, 2 . . . and simultaneously, on the remote user device, for WiFi module 820, it sequentially sets the mmWave array to beam k (i.e., uses kth antenna weight vector) where k=1, 1, 2 . . . and run the throughput test for each (n,k) beam pair. WiFi AP 810 then selects a set of beam pair (x,y) that gives the highest throughput beam for WiFi AP 801 and WiFi module 820 from the beam pairings. In a second method, for WiFi AP 810, it evokes a channel sounding a feedback protocol for each of the nth mmWave array beam (i.e., nth antenna weight vector) n=0, 1, 2 . . . and for the remote user for each of the kth mmWave array beam (i.e., kth antenna weight vector) k=0, 1, 2 . . . by using WiFi device application interface (API) and retrieve the channel measurements on both sides. WiFi AP 810 then selects the beam pairing with the highest channel capacity for each remote user device. Note channel capacity is computed from sounding feedback measurements, and this method requires interfacing to WiFi device API to enable the channel sounding and feedback protocol. The sounding and feedback information are available via the API of the WiFi device, which is different from the regular WiFi control and data path interface.

FIG. 9 illustrates a WiFi protocol for channel sounding and feedback applied for beam training in mmWave systems. In the example of FIG. 9, AP 910 performs channel sounding and feedback with stations STA1 and STA2. For downlink transmission, AP 910 (initiator) first broadcasts a sounding announcement NDPA 911 to inform the intended stations (responders) and a sounding signal NDP 912 is then transmitted for the intended responders. Based on the received sounding signal, each STA measures the downlink channel and estimates CSI and SNR/SNIR. For uplink transmission, STA1 transmits CSI feedback message 921 after receiving NDP 912 (with SIFS/RIFS), STA2 transmits CSI feedback packet 931 after receiving polling message 913 from AP 910. For mmWave systems, the channel sounding and feedback process is repeated for all beam pair combinations between AP and STA1/STA2 to find the best beam pair with highest channel capacity.

FIG. 10 illustrates one embodiment of implementing sounding and feedback applied for beam training in mmWave systems. At the network side, WiFi AP 1010 is coupled to a 28 GHz mmWave antenna and converter 1011. At the user side, WiFi module 1020 is coupled to a 28 GHz mmWave antenna and converter 1021. To perform beam training, WiFi AP and WiFi module applies a WiFi channel sounding and feedback protocol for each beam pair to find the best beam pair with TX and RX beam index. The wideband mmWave system employs the WiFi channel sounding and feedback protocol for beam training by going through different beam pair combinations between WiFi AP and WiFi module. Note that the 28 GHz mmWave antenna and converter needs to up-convert the WiFi signal with multiple spatial streams (MIMO signal) into a wideband mmWave signal in the TX direction, and down-convert the mmWave signal to multiple WIFI spatial streams (MIMO signal) in the RX direction. A T/R switch control signal activates TX or RX at the 28 GHz mmWave module. Each time a sounding signal in sent from WiFi AP 1010 via 28 GHz mmWave antenna and converter 1011, the channel quality (signal-to-noise ratio, signal-to-noise-interference ratio, or channel state information) is feedback from WiFi module 1020 via 28 GHz mmWave antenna and converter 1021. The channel sounding and feedback protocol performed by the WiFi AP will automatically derives a transmit beamforming matrix that splits the multiple WiFi spatial streams into multiple antennas.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A client-side access device, comprising:
a WiFi module;
a bridge that couples the WiFi module to an indoor Ethernet network;
a millimeter wave (mmWave) antenna; and
a millimeter wave (mmWave) converter that couples the WiFi module to the mmWave antenna, wherein the mmWave converter up-converts a first WiFi signal to a first mmWave signal and transmits out via the mmWave antenna, wherein the mmWave converter receives a second mmWave signal via the mmWave antenna and down-converts to a second WiFi signal, and wherein the transmitting and receiving operation is controlled by a switch control signal.

2. The access device of claim 1, wherein the WiFi module operates in a regular WiFi basic service set (BSS), wherein the WiFi module is associated to a WiFi access point (AP) identified by a BSSID.

3. The access device of claim 1, wherein the mmWave converter up-converts multiple WiFi spatial streams to corresponding multiple mmWave subchannels, wherein the multiple mmWave subchannels form a wideband signal having a total bandwidth equal to a sum of bandwidths of the multiple WiFi spatial streams.

4. The access device of claim 3, wherein the multiple WiFi spatial streams are up-converted to different mmWave phased-arrays by applying with a different frequency offset.

5. The access device of claim 3, wherein the multiple WiFi spatial streams are up-converted by applying with a different frequency offset and then aggregated to the same mmWave phased-array.

6. The access device of claim 1, wherein the mmWave converter down-converts a wideband signal comprising multiple mmWave subchannels, wherein the multiple mmWave subchannels are down-converted to corresponding multiple WiFi spatial streams, and wherein the wideband signal having a total bandwidth equal to a sum of bandwidths of the multiple WiFi spatial streams.

7. The access device of claim 1, wherein the device performs beam training using a WiFi channel sounding and feedback protocol.

8. The access device of claim 7, wherein the WiFi module comprises an API interface for activating the beam training for each beam index to find the best beam pair.

9. The access device of claim 7, wherein the beam training is activated multiple times to confirm a selected transmit beam and a selected receive beam.

10. The access device of claim 1, wherein the device further comprises a transmit/receive (T/R) switch providing the switch control signal.

11. A network-side access device, comprising:
one or more WiFi access points (APs) coupled to an Ethernet switch;
one or more millimeter-wave (mmWave) antennas; and
one or more millimeter-wave (mmWave) converters that couples each WiFi AP to each mmWave antenna, wherein each mmWave converter up-converts a first WiFi signal to a first mmWave signal and transmits out via a corresponding mmWave antenna, wherein each mmWave converter receives a second mmWave signal via the corresponding mmWave antenna and down-converts to a second WiFi signal, and wherein the transmitting and receiving operation is controlled by a switch control signal.

12. The access device of claim 11, wherein the WiFi AP operates in a regular WiFi basic service set (BSS), wherein the WiFi AP is associated to a WiFi module at a client side identified by a BSSID.

13. The access device of claim 11, wherein each mmWave converter up-converts multiple WiFi spatial streams to corresponding multiple mmWave subchannels, wherein the multiple mmWave subchannels form a wideband signal having a total bandwidth equal to a sum of bandwidths of the multiple WiFi spatial streams.

14. The access device of claim 11, wherein the mmWave converter down-converts a wideband signal comprising multiple mmWave subchannels, wherein the multiple mmWave subchannels are down-converted to corresponding multiple WiFi spatial streams, and wherein the wideband signal having a total bandwidth equal to a sum of bandwidths of the multiple WiFi spatial streams.

15. The access device of claim 11, wherein the WiFi AP performs beam training using a WiFi channel sounding and feedback protocol.

16. The access device of claim 15, wherein the WiFi AP comprises an API interface for activating the beam training for each beam to find the best beam pair.

17. The access device of claim 15, wherein the beam training is activated multiple times to confirm a selected transmit beam and a selected receive beam.

18. The access device of claim 11, wherein different mmWave signals of different mmWave converters are spatially multiplexed with each other to increase a system throughput.

19. The access device of claim 11, wherein the Ethernet switch couples the one or multiple WiFi APs to a core data network.

20. The access device of claim 19, wherein multiple WiFi APs operate independently via spatially separated mmWave beams, and wherein data traffic of the multiple WiFi APs are aggregated via the Ethernet switch.

21. The access device of claim 11, wherein the access device is a base station (BS).

22. The access device of claim 1, wherein the device further comprises a transmit/receive (T/R) switch providing the switch control signal.
